(19) United States
(12) Patent Application Publication
(10) Pub. No.: US 2008/0047949 A1
(43) Pub. Date: Feb. 28, 2008

(54) Air flow cooker

(76) Inventor: Daniel Rustin, Vidalia, GA (US)

Correspondence Address: NIXON & VANDERHYE, PC, 901 NORTH GLEBE ROAD, 11TH FLOOR, ARLINGTON, VA, 22203, US

(21) Appl. No.: 11/500,506

(22) Filed: Aug. 8, 2006

(51) Int. Cl. A21B 1/22

(52) U.S. Cl. 219/400

(57) ABSTRACT

A convection cooking apparatus includes a cabinet including sides and a bottom, and a lid attached to the cabinet and pivotable between a closed position and an open position. A divider is disposed in the cabinet and divides the cabinet into a heating chamber and a cooking chamber. A cooking grate extends across a width of the cabinet over the heating chamber, the divider, and the cooking chamber. The cabinet also includes an air inlet in the heating chamber and an air outlet in the cooking chamber. The simplified design is less expensive to manufacture, while the construction maintains air-flow characteristics to preserve cooking performance.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The present invention relates to convection cookers or grills and, more particularly, to a convection cooker/grill utilizing a simplified construction while maintaining cooking performance.

It is desirable to cook items using a heat source such as a propane gas flame or the like without having to expose the items directly to the flame or other heating element. Convection ovens typically utilize a fan or other air-drafting structure to circulate heat from a heat source to food items situated away from the heat source. U.S. Pat. No. 6,038,964 is exemplary and utilizes a drafting means attached to an air outlet, such as a chimney with elongated flue or a fan, to create an air-flow through an air inlet, an air passage, and the air outlet. The construction is more complicated than necessary, however, resulting in increased production costs. Additionally, the structure for creating an air-flow through the cabinet further adds to production costs. Still further, the commercial embodiment utilizes aluminum for its cabinet and some internal components, which aluminum tends to melt during use causing warping at high temperatures.

It would be desirable to provide a convection cooker or grill that is simpler in construction and therefore less expensive to manufacture, while maintaining air-flow characteristics to preserve cooking performance.

### BRIEF SUMMARY OF THE INVENTION

The convection cooker described herein utilizes a simplified design to effect convection cooking without the use of added structure to create an air-flow through the cabinet. The cooker includes a cabinet divided into a heating chamber and a cooking chamber. An air inlet is provided in the heating chamber, and an air outlet is disposed below the cooking grate in the cooking chamber. It has been discovered that air-flow from the inlet, which is heated via the heating chamber, flows naturally toward the cooking chamber during use. Air-flow from the heating chamber is evenly passed over the food on the grate and flows naturally to the air outlet. A guide vane is provided to guide exiting air through the outlet.

In an exemplary embodiment of the invention, a convection cooking apparatus includes a cabinet including sides and a bottom, and a lid attached to the cabinet and pivotable between a closed position and an open position. A divider is disposed in the cabinet and divides the cabinet into a heating chamber and a cooking chamber. A cooking grate extends across a width of the cabinet over the heating chamber, the divider, and the cooking chamber. The cabinet also includes an air inlet in the heating chamber and an air outlet in the cooking chamber disposed below the grate.

In one arrangement, the apparatus further includes an air diverter coupled with the lid. In this context, with the lid in the closed position, the air diverter extends at an angle toward the cooking chamber from a position adjacent the cooking grate to a position adjacent the lid top. The divider may be bent to direct heated air into the air diverter.

A guide vane may be disposed adjacent the air outlet.

The cabinet bottom is preferably sealed to contain a liquid volume, where the cabinet bottom has a valve therein to facilitate draining of the liquid volume.

In another exemplary embodiment of the invention, a convection cooking apparatus includes a cabinet including sides and a bottom; a lid attached to the cabinet and pivotable between a closed position and an open position, the lid including an air diverter; a divider disposed in the cabinet and dividing the cabinet into a heating chamber and a cooking chamber; a cooking grate extending across a width of the cabinet over the heating chamber, the divider, and the cooking chamber; an air inlet in the heating chamber; and an air outlet in the cooking chamber. During cooking, heated air rises from the heating chamber. The air diverter is positioned in a path of the rising heated air to divert the heated air toward the cooking chamber. The air outlet is positioned relative to the cooking grate so that heated air exiting the cabinet is passed through the cooking grate.

In still another exemplary embodiment of the invention, a dual cooking apparatus includes a cabinet including sides and a bottom; a lid attached to the cabinet and pivotable between a closed position and an open position; a divider disposed in the cabinet and dividing the cabinet into a heating chamber and a cooking chamber; an air inlet in the heating chamber; and an air outlet in the cooking chamber. A cooking grate extends linearly across a width of the cabinet over the heating chamber, the divider, and the cooking chamber such that the cooking grate defines a convection cooking portion over the cooking chamber and a conduction cooking portion over the heating chamber.

### BRIEF DESCRIPTION OF THE DRAWINGS

These and other aspects and advantages of the present invention will be described in detail with reference to the accompanying drawings, in which:

FIG. 1 is a front view of the convection cooker described herein showing interior components of the cooker;

FIG. 2 is a plan view of the convection cooker described herein; and

FIG. 3 is a perspective view of the convection cooker with the lid removed.

### DETAILED DESCRIPTION OF THE INVENTION

With reference to the FIGURES, the cooking apparatus 10 includes a cabinet 12 having sides 14 and a bottom 16 and a lid 18 pivotably attached to the cabinet 12 via a suitable hinge 20 or the like. The lid 18 is pivotable between a closed position and an open position. The cabinet 12 is preferably formed of stainless steel.

A divider 22, preferably also of stainless steel, is disposed in the cabinet 12 and divides the cabinet 12 into a heating chamber 24 and a cooking chamber 26. A cooking grate 28 extends across a width of a cabinet 12 over the heating chamber 24, the divider 22 and the cooking chamber 26. An air inlet 30 is defined in the heating chamber 24, and an air outlet 32 is defined in the cooking chamber. Preferably, as shown, the air outlet 32 is disposed below the cooking grate 28.

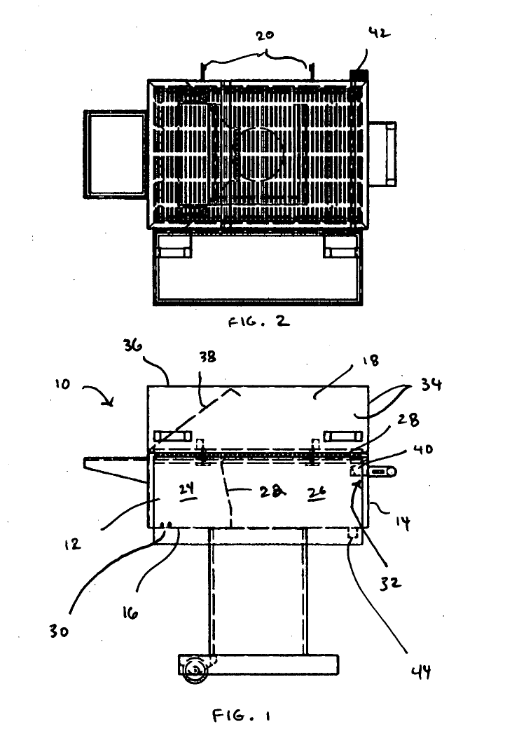

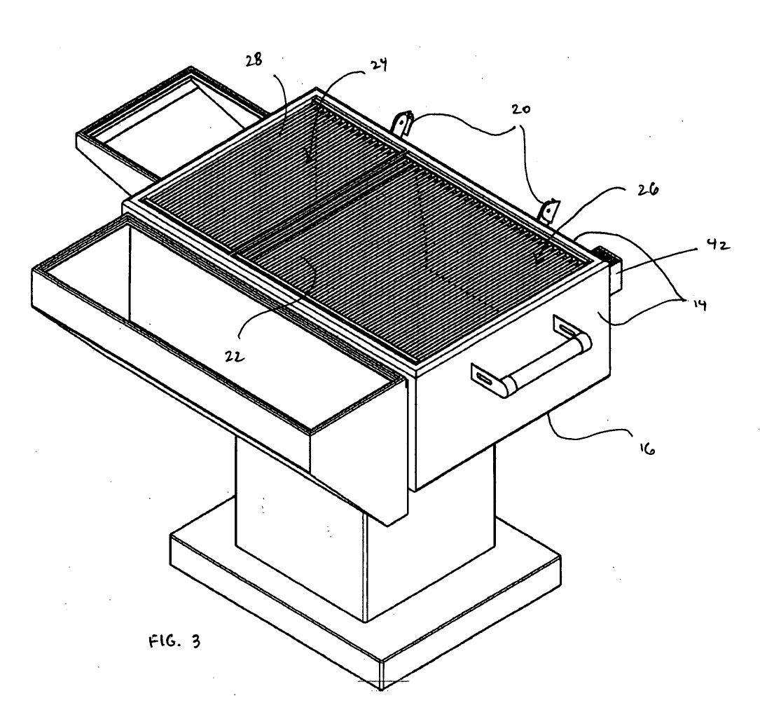

As shown, the lid 18 includes sides 34 and a top 36. The cooking apparatus 10 preferably additionally includes an air diverter 38 coupled with the lid 18. With the lid 18 in the closed position (FIG. 1), the air diverter 38 extends at an angle toward the cooking chamber 26 from a position adjacent the cooking grate 28 to a position adjacent the lid top 36. In one arrangement, as illustrated in FIGS. 1 and 3, the divider 22 may be bent to direct heated air into the air diverter 38.

A guide vane 40 is preferably disposed adjacent the air outlet 32. The guide vane 40 does not perform any drafting function to create air flow through the cabinet 12, but rather merely guides exiting air through the air outlet 32. The guide vane 40 may guide the exiting air to an exit opening 42 on a back side of the cabinet 12.

The cabinet 12 and cabinet bottom 16 are preferably sealed to contain a liquid volume, such as water. Including an approximate two inch reservoir at the bottom of the cabinet 12 facilitates clean-up of grease and food droppings as a result of cooking. In this context, the cabinet 12 may be provided with a valve 44, such as a ball valve or the like, for draining the liquid volume from the cabinet 12.

A heating element (not shown) is disposed in the heating chamber 24 to create heated air. Any suitable heating element may be utilized, and the invention is not meant to be limited to any particular element. Exemplary heating elements include, without limitation, propane flame, natural gas flame, charcoal, etc.

In use, upon ignition of the heating element, heated air rises from the heating chamber 24. If a diverter 38 is installed, the air diverter 38 positioned in a path of the rising heated air diverts the heated air toward the cooking chamber 26. In the embodiment utilizing a bent divider 22, the bent divider serves to direct the heated air toward the air diverter 38. This twice-reversing direction of the heated air creates a swirling flow of heated air, which is directed toward the cooking chamber 26. The heated air then flows through the cooking grate 28 in the cooking chamber 26 (and through any food to be cooked sitting on the cooking grate 28). As the hotter air from the heating chamber 24 fills the closed lid 18, the heated air is directed down through the grate 28, and through the air outlet 32 beneath the grate 28 at the opposite side of the cabinet 12.

The cooking grate 28 preferably extends linearly (i.e., at a constant level) across the width of the cabinet 12 over both the heating chamber 24 and the cooking chamber 26. As such, in addition to convection cooking of food disposed on the grate 28 in the cooking chamber 26, if desirable, food items can be placed on the cooking grate 28 directly above the heating chamber 24 to thereby effect conduction cooking or direct heat cooking over the heating chamber 24. The cooking grate 28 thus defines a convection cooking portion over the cooking chamber 26 and a conduction or direct heat cooking portion over the heating chamber 24.

The simplified construction of the cooker described herein is less expensive to manufacture than conventional convection cookers while maintaining air-flow characteristics to preserve cooking performance. Air flow that is heated via the heating chamber flows naturally toward the cooking chamber during use, which flow direction may be facilitated with an air diverter attached to the lid. This natural flow provides consistent heated air passed evenly over the food on the cooking grate for exceptional cooking performance.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A convection cooking apparatus comprising:
a cabinet including sides and a bottom;
a lid attached to the cabinet and pivotable between a closed position and an open position;
a divider disposed in the cabinet and dividing the cabinet into a heating chamber and a cooking chamber;
a cooking grate extending across a width of the cabinet over the heating chamber, the divider, and the cooking chamber;
an air inlet in the heating chamber; and
an air outlet in the cooking chamber disposed below the cooking grate.

2. A convection cooking apparatus according to claim 1, wherein the lid comprises sides and a top, the convection cooking apparatus further comprising an air diverter coupled with the lid, wherein with the lid in the closed position, the air diverter extends at an angle toward the cooking chamber from a position adjacent the cooking grate to a position adjacent the lid top.

3. A convection cooking apparatus according to claim 2, wherein the divider is bent to direct heated air into the air diverter.

4. A convection cooking apparatus according to claim 1, further comprising a guide vane disposed adjacent the air outlet.

5. A convection cooking apparatus according to claim 1, wherein the cabinet bottom is sealed to contain a liquid volume, and wherein the cabinet bottom comprises a valve therein to facilitate draining the liquid volume.

6. A convection cooking apparatus comprising:
a cabinet including sides and a bottom;
a lid attached to the cabinet and pivotable between a closed position and an open position, the lid including an air diverter;
a divider disposed in the cabinet and dividing the cabinet into a heating chamber and a cooking chamber;
a cooking grate extending across a width of the cabinet over the heating chamber, the divider, and the cooking chamber;
an air inlet in the heating chamber; and
an air outlet in the cooking chamber,
wherein during cooking, heated air rises from the heating chamber, wherein the air diverter is positioned in a path of the rising heated air to divert the heated air toward the cooking chamber, and wherein the air outlet is positioned relative to the cooking grate so that heated air exiting the cabinet is passed through the cooking grate.

7. A convection cooking apparatus according to claim 6, wherein the divider is bent to direct heated air into the air diverter.

8. A dual cooking apparatus comprising:
a cabinet including sides and a bottom;
a lid attached to the cabinet and pivotable between a closed position and an open position;
a divider disposed in the cabinet and dividing the cabinet into a heating chamber and a cooking chamber;
an air inlet in the heating chamber;
an air outlet in the cooking chamber; and
a cooking grate extending linearly across a width of the cabinet over the heating chamber, the divider, and the cooking chamber, the cooking grate defining a convection cooking portion over the cooking chamber and a conduction cooking portion over the heating chamber.

9. A dual cooking apparatus according to claim 8, wherein the lid comprises sides and a top, the convection cooking apparatus further comprising an air diverter coupled with the lid, wherein with the lid in the closed position, the air diverter extends at an angle toward the cooking chamber from a position adjacent the cooking grate to a position adjacent the lid top.

10. A dual cooking apparatus according to claim 9, wherein the divider is bent to direct heated air into the air diverter.
